(19) United States
(12) Patent Application Publication
(10) Pub. No.: US 2025/0298561 A1
(43) Pub. Date: Sep. 25, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Shogo ISHIKAWA, Kanagawa (JP)

(73) Assignee: FUJIFILM Business Innovation Corp., Tokyo (JP)

(21) Appl. No.: 18/818,640

(22) Filed: Aug. 29, 2024

(30) Foreign Application Priority Data
Mar. 21, 2024 (JP) 2024-045320

(51) Int. Cl. G06F 3/12

(52) U.S. Cl. CPC G06F 3/1237; G06F 3/1208

(57) ABSTRACT

An information processing system includes a processor configured to, in a case where input information including print job information is input, by inputting new input information including information related to a new print job to a trained model that has been trained in advance to output information related to a threshold value for inspection performed on printed matter to be printed using the print job, output information related to a threshold value for inspection corresponding to the new input information.

### CROSS-REFERENCE TO RELATED APPLICATIONS

This application is based on and claims priority under 35 USC 119 from Japanese Patent Application No. 2024-045320 filed Mar. 21, 2024.

### BACKGROUND

### (i) Technical Field

The present disclosure relates to an information processing system, a non-transitory computer readable medium storing an information processing program, and an information processing method.

### (ii) Related Art

JP2023-136927A discloses a printed matter inspection system including a processor configured to inspect the quality of printed matter, and a display unit that displays a result of the inspection, in which the processor is configured to, by reading and executing a program, compare a scan image obtained by scanning the printed matter of a page to be inspected among pages constituting a job with a reference image created using rasterized data of the page to be inspected, inspect a first defect present in the scan image using a first threshold value for inspection at an initial level which is preset or a level which is set by a user, automatically inspect a second defect present in the scan image at a second threshold value for inspection, which is different from the first threshold value for inspection, and display the first defect and the second defect on the display unit in a distinguishable manner.

In the printing business, defects in printed matter used to be checked by human eyes, but in recent years, detection using an inspection apparatus is possible. In the detection using the inspection apparatus, defects are detected using automatic determination by a machine, and micro defects that cannot be discriminated by the human eyes may be detected as defects depending on the threshold value for inspection in the inspection apparatus, so that there is a case of making the inspection results complicated or resulting in unnecessary disposal of the paper, thereby requiring re-printing. Therefore, setting of the threshold value for inspection used for the inspection of printed matter is necessary to be close to the accuracy of visual confirmation.

In JP2023-136927A, a plurality of threshold values for inspection are prepared in advance, and one of the threshold values for inspection is designated in a print job. The inspection results corresponding to all the threshold values can be internally held in a case where the print job is inspected, and the display of the defect for each threshold value for inspection can be dynamically switched in a case where the inspection results are displayed. The technique disclosed in JP2023-136927A is merely an assistance for a user operation, and the most significant threshold value for inspection is determined manually. In other words, the output of the determined threshold value for inspection is performed manually.

### SUMMARY

Aspects of non-limiting embodiments of the present disclosure relate to an information processing system, a non-transitory computer readable medium storing an information processing program, and an information processing method, which can output a threshold value for inspection according to a print job.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, in a case where input information including print job information is input, by inputting new input information including information related to a new print job to a trained model that has been trained in advance to output information related to a threshold value for inspection performed on printed matter to be printed using the print job, output information related to a threshold value for inspection corresponding to the new input information.

### BRIEF DESCRIPTION OF THE DRAWINGS

Exemplary embodiment(s) of the present invention will be described in detail based on the following figures, wherein:

FIG. 1 is a diagram showing a schematic configuration of an information processing system according to the present exemplary embodiment;

FIG. 2 is a block diagram showing a main configuration of electrical systems of a printing apparatus in the information processing system according to the present exemplary embodiment;

FIG. 3 is a block diagram showing a main configuration of electric systems of a management apparatus and a client computer in the information processing system according to the present exemplary embodiment;

FIG. 4 is a functional block diagram showing a functional configuration of the client computer in the information processing system according to the present exemplary embodiment;

FIG. 5 is a diagram showing an example of a trained neural network model;

FIG. 6 is a flowchart showing an example of a flow of a training process performed by the client computer of the information processing system according to the present exemplary embodiment; and

FIG. 7 is a flowchart showing an example of a flow of an estimation process performed by the client computer of the information processing system according to the present exemplary embodiment.

### DETAILED DESCRIPTION

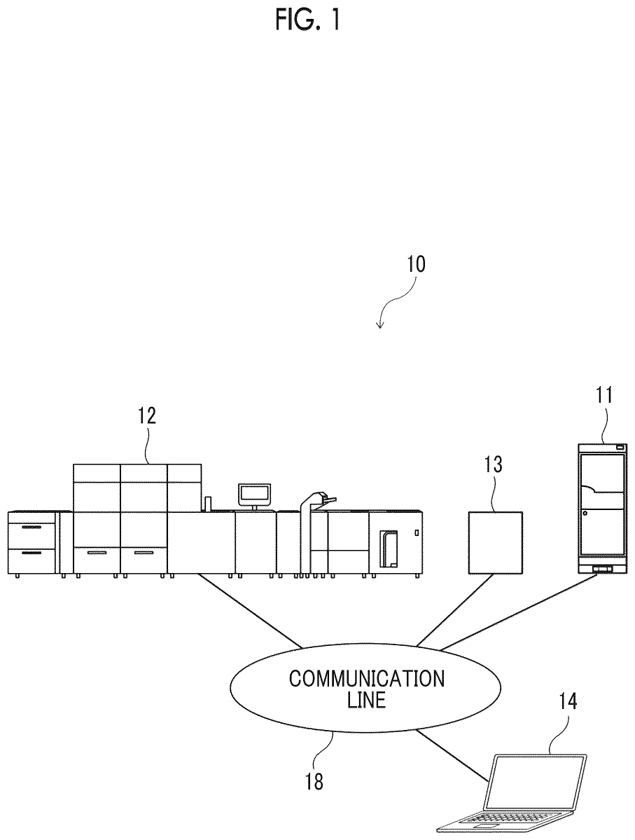

Hereinafter, an example of the present exemplary embodiment will be described in detail with reference to the drawings. In the present exemplary embodiment, an information processing system in which a management apparatus, a printing apparatus, a client computer, and the like are connected to each other via a communication line such as various networks is described as an example. FIG. 1 is a diagram showing a schematic configuration of an information processing system 10 according to the present exemplary embodiment.

As illustrated in FIG. 1, an information processing system 10 according to the present exemplary embodiment includes a management apparatus 11, a printing apparatus 12, an inspection apparatus 13, a client computer 14, and the like. The management apparatus 11, the printing apparatus 12, the inspection apparatus 13, and the client computer 14 are connected to each other via a communication line 18 such as a Local Area Network (LAN), a Wide Area Network (WAN), the Internet, an intranet, and the like. Then, each of the management apparatus 11, the printing apparatus 12, the inspection apparatus 13, and the client computer 14 can transmit and receive various data to and from each other via the communication line 18. In the present exemplary embodiment, by giving a print instruction to the printing apparatus 12 from the client computer 14 via the management apparatus 11, an image corresponding to the print instruction is formed in the printing apparatus 12.

In FIG. 1, one management apparatus 11, one printing apparatus 12, one inspection apparatus 13, and one client computer 14 are shown, but each of the apparatuses may be plural or any of the apparatuses may be plural.

The printing apparatus 12 according to the present exemplary embodiment has a plurality of functions such as a printing function of performing printing process and a post-treatment function of performing post-treatment on printed paper. The plurality of functions may include a scanning function of scanning a manuscript to obtain image information indicating the manuscript, a duplicating function of duplicating an image recorded in the manuscript on paper, a facsimile function of transmitting and receiving various data via a telephone line (not shown), a transfer function of transferring manuscript information such as the image information scanned by the scanning function, and an accumulating function of accumulating the manuscript information such as the scanned image information.

In the following description, the facsimile function may be referred to as a fax, the scanning function may be referred to as a scan, the printing function may be referred to as a print, and the duplicating function may be referred to as a copy.

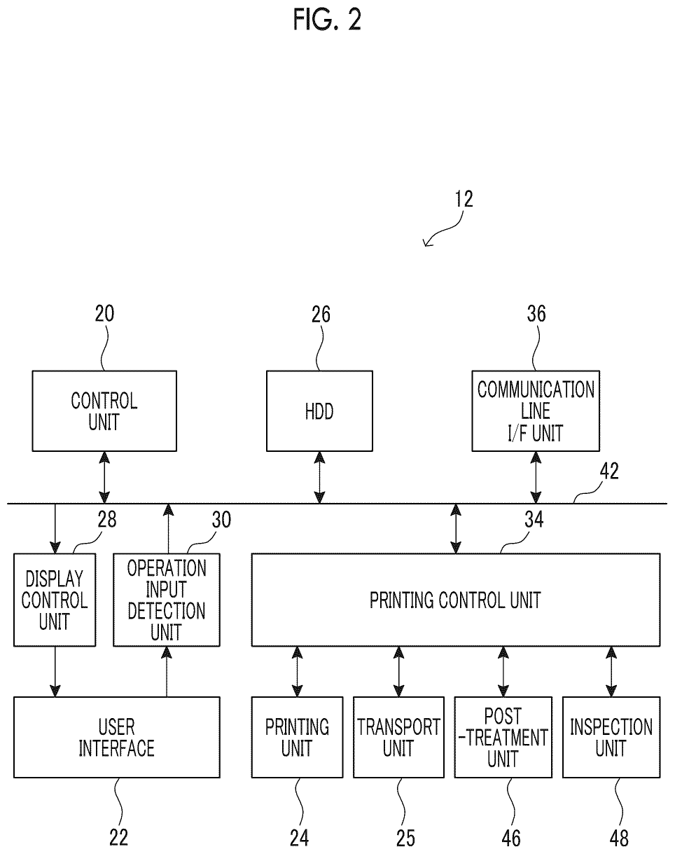

FIG. 2 is a block diagram showing a main configuration of electric systems of the printing apparatus 12 in the information processing system 10 according to the present exemplary embodiment.

As shown in FIG. 2, the printing apparatus 12 according to the present exemplary embodiment includes a control unit 20. The control unit 20 may include a Central Processing Unit (CPU), a Read Only Memory (ROM), and a Random Access Memory (RAM).

On the other hand, the printing apparatus 12 according to the present exemplary embodiment includes a Hard Disk Drive (HDD) 26 that stores various data, application programs, and the like. In addition, the printing apparatus 12 includes a display control unit 28 that is connected to a user interface 22 and controls the display of various operation screens and the like on the display of the user interface 22. Further, the printing apparatus 12 includes an operation input detection unit 30 that is connected to the user interface 22 and detects an operation instruction input via the user interface 22. In the printing apparatus 12, the HDD 26, the display control unit 28, and the operation input detection unit 30 are electrically connected to a system bus 42. In the printing apparatus 12 according to the present exemplary embodiment, the HDD 26 is applied as a storage unit, but the present disclosure is not limited thereto, and a non-volatile storage unit such as a flash memory may be applied. In addition, in the present exemplary embodiment, a touch panel that can perform display and operation input is applied to the user interface 22, but the present disclosure is not limited thereto, and a user interface in which a display and an operation unit are separate may be applied.

In addition, the printing apparatus 12 according to the present exemplary embodiment includes a printing control unit 34 that controls a printing process by the printing unit 24, the transport of the paper to the printing unit 24 by the transport unit 25, the post-treatment by the post-treatment unit 46, and a scanning process of the printed matter by the inspection unit 48. The printing apparatus 12 may include a scanning control unit that controls an optical image scanning operation by a manuscript scanning unit and a manuscript feeding operation by a manuscript transport unit. In addition, the printing apparatus 12 includes a communication line interface (I/F) unit 36 that is connected to the communication line 18 and transmits and receives communication data to and from other external apparatuses such as the client computer 14 connected to the communication line 18. Further, the printing apparatus 12 may include a facsimile interface (I/F) unit that is connected to a telephone line (not shown) and transmits and receives facsimile data to and from a facsimile apparatus connected to the telephone line. In addition, the printing apparatus 12 may include a transmission and reception control unit that controls transmission and reception of the facsimile data via the facsimile I/F unit 38. Moreover, in the printing apparatus 12, the printing control unit 34 and the communication line I/F unit 36 are electrically connected to a system bus 42.

With the above configuration, the printing apparatus 12 according to the present exemplary embodiment executes control of display of an operation screen and information, such as various messages, on the display of the user interface 22 via the display control unit 28 by the control unit 20. In addition, the printing apparatus 12 executes, by the control unit 20, each of the control of the operation of the printing unit 24, the transport unit 25, the post-treatment unit 46, and the inspection unit 48 via the printing control unit 34, and the control of the transmission and reception of the communication data via the communication line I/F unit 36. Further, the printing apparatus 12 grasps operation content in the user interface 22 based on operation information, which is detected by the operation input detection unit 30, by the control unit 20 and executes various controls based on the operation content.

As an example of the applications stored in the HDD 26, in the present exemplary embodiment, an application that executes a function such as printing is included.

The inspection apparatus 13 performs inspection of the printed matter by comparing the raster image indicated by the print information with the scan image of the printed matter obtained by the inspection unit 48 in a case where the printing apparatus 12 performs printing based on the print information. In this case, the inspection apparatus 13 performs inspection of the printed matter using information related to a threshold value for inspection of the printed matter. The information related to a threshold value for inspection is, for example, a threshold value for determining NG related to the difference between the raster image indicated by the print information and the scan image of the printed matter, and includes a threshold value set for a difference in color or magnitude.

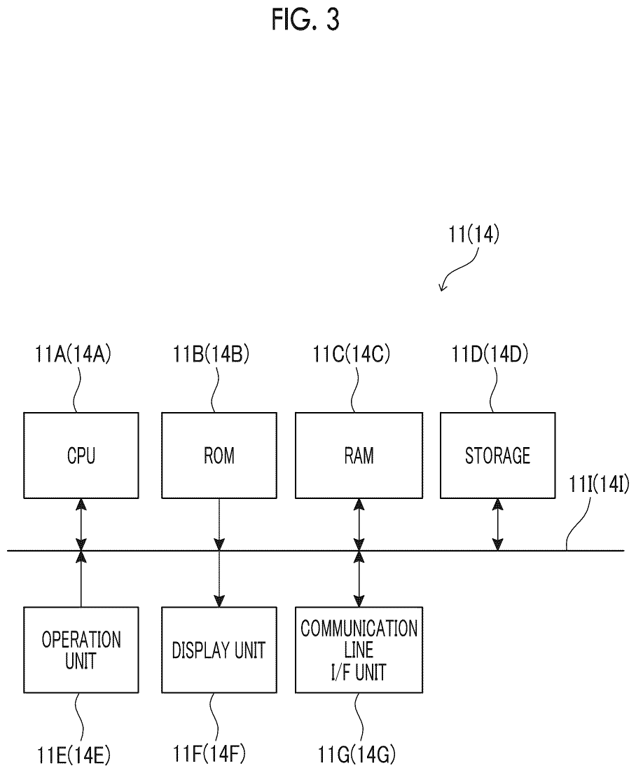

Subsequently, a main configuration of the electric systems of the management apparatus 11 and the client computer 14 according to the present exemplary embodiment will be described. FIG. 3 is a block diagram showing a main configuration of the electric systems of the management apparatus 11 and the client computer 14 in the information processing system 10 according to the present exemplary embodiment. Since the management apparatus 11 and the client computer 14 have a general computer configuration, the management apparatus 11 will be described below as a representative example.

As illustrated in FIG. 3, the management apparatus 11 according to the present exemplary embodiment includes a CPU 11A as an example of a processor, a ROM 11B, a RAM 11C, a storage 11D, an operation unit 11E, a display unit 11F, and a communication line interface (I/F) unit 11G. The CPU 11A administers the whole operation of the management apparatus 11. The ROM 11B stores various control programs, various parameters, and the like in advance. The RAM 11C is used as a work area or the like in a case where various programs are executed by the CPU 11A. The storage 11D stores various data, application programs, and the like. The operation unit 11E is used to input various types of information. The display unit 11F is used for display of the various types of information. The communication line I/F unit 11G is connected to the communication line 18 and transmits and receives various data to and from other apparatuses connected to the communication line 18. In addition, the communication line I/F unit 11G may have a configuration capable of directly communicating with each device by using various well-known wireless communications. Each of the units of the management apparatus 11 described above is electrically connected to each other by a system bus 11I. In the management apparatus 11 according to the present exemplary embodiment, the storage 11D is applied as a storage unit, but as an example of the storage, a non-volatile storage unit, such as a Hard Disk Drive (HDD) or a flash memory, is applied.

With such a configuration, in the management apparatus 11 according to the present exemplary embodiment, the CPU 11A executes accesses to the ROM 11B, the RAM 11C, and the storage 11D, acquisition of various types of data via the operation unit 11E, and display of various types of information on the display unit 11F. In addition, the management apparatus 11 executes control of transmission and reception of the communication data via the communication line I/F unit 11G by the CPU 11A.

In the information processing system 10 having the above-described configuration, the management apparatus 11 manages a series of manufacturing procedures. The series of manufacturing procedures includes, for example, a manufacturing procedure, a pre-press procedure, a plate-making procedure, a printing procedure, a processing procedure, and a distribution procedure.

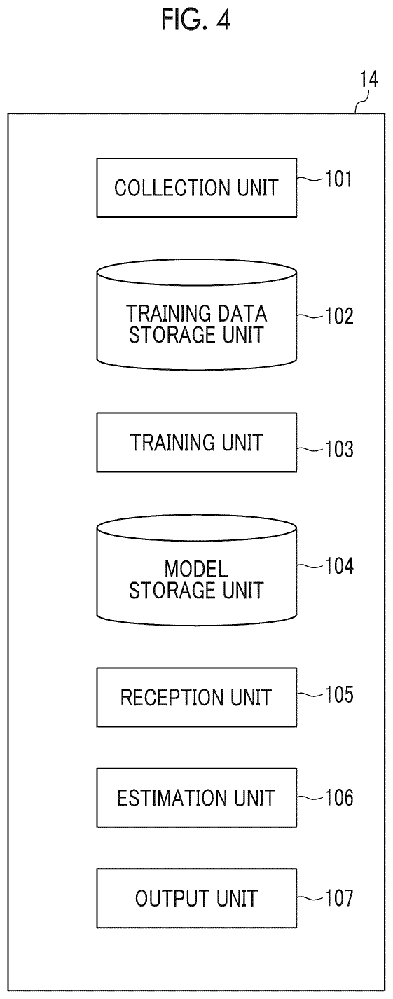

Next, a functional configuration of the client computer 14 will be described. FIG. 4 is a block diagram showing an example of the functional configuration of the client computer 14.

Functionally, as shown in FIG. 4, the client computer 14 is configured to include a collection unit 101, a training data storage unit 102, a training unit 103, a model storage unit 104, a reception unit 105, an estimation unit 106, and an output unit 107.

The collection unit 101 collects training data including a pair of input information related to a past print job and information related to a threshold value for inspection of the printed matter corresponding to the input information.

The input information may include print job information. The print job information may include information related to the type of printed matter or an image to be printed.

Specifically, the type of printed matter includes, for example, a photo album, a poster, a magazine, a flyer, an envelope, a business card, a catalog, a newspaper, and the like.

The management apparatus 11 has history information for managing information related to an order reception for a printed matter and manufacturing information.

The collection unit 101 collects the type of printed matter in past order from the history information of the management apparatus 11.

In addition, the information related to an image to be printed includes information on an object included in an image to be printed using the print job or information on the color. The information on an object included in an image to be printed may include a ratio of image information to text information on each page, the number of pages primarily composed of on image information, the number of pages primarily composed of text information, or an image density. The information on the color included in an image to be printed includes, for example, primary color information.

The collection unit 101 acquires information related to the image to be printed from the history information included in the management apparatus 11.

In addition, the input information may include information on an order of printed matter. Specifically, the information on an order of printed matter includes information for identifying the order. The information for identifying an order includes, for example, an ID or a number for identifying the order.

The collection unit 101 acquires information on an order of printed matter from the history information included in the management apparatus 11.

The input information may include information on the printing apparatus 12 that processes the print job or information on the inspection apparatus 13 that performs inspection of the printed matter.

Specifically, the information on the printing apparatus 12 that processes the print job includes information for identifying the printing apparatus 12 or information for indicating a model. The information for identifying the printing apparatus 12 includes, for example, an ID or a number for identifying the printing apparatus 12. The information on the inspection apparatus 13 that performs inspection of the printed matter includes information for identifying the inspection apparatus 13 or information for indicating a model. The information for identifying the inspection apparatus 13 includes, for example, an ID or a number for identifying the inspection apparatus 13.

The collection unit 101 acquires the information on the printing apparatus 12 that processes the print job or the information on the inspection apparatus 13 that performs inspection of the printed matter, from the history information included in the management apparatus 11.

The information related to a threshold value for inspection of the printed matter corresponding to the past print job is managed by the management apparatus 11 as the history information, and the collection unit 101 acquires the information related to a threshold value for inspection from the management apparatus 11.

Specifically, with respect to the past print job, the information related to a threshold value for inspection of the printed matter set manually is managed by the management apparatus 11 as the history information. The collection unit 101 acquires the information related to a threshold value for inspection set manually as correct answer information from the management apparatus 11.

The training data storage unit 102 stores a plurality of pieces of training data collected by the collection unit 101.

Based on the plurality of pieces of training data, the training unit 103 constructs a neural network model where the input information is used as input and the information related to a threshold value for inspection corresponding to the input information is used as output.

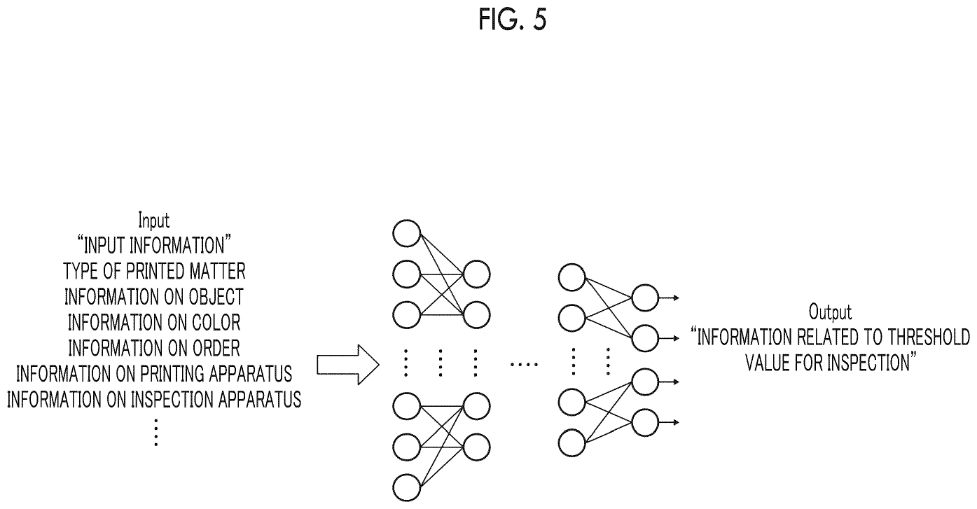

Specifically, the trained neural network model receives input of the input information that includes at least one of the type of printed matter, the information on an object, the information on a color, the information on an order, the information on the printing apparatus 12, or the information on the inspection apparatus 13, and estimates information related to a threshold value for inspection corresponding to the input information (see FIG. 5). As an example of a training algorithm, deep learning can be used, and the neural network model may be constructed such that the information related to a threshold value for inspection of the training data is output in a case where the input information of the training data is input.

More specifically, the parameters of the model may be updated to use the input information on the training data as the input, to estimate the information related to a threshold value for inspection as the output of the model, to calculate the error of the information related to a threshold value for inspection by comparing the estimated information related to a threshold value for inspection with information related to a threshold value for inspection of the training data, thereby minimizing the value of the error.

Here, a correlation between various types of information included in the input information and the information related to a threshold value for inspection will be described.

First, the threshold value for inspection, which is easily set for each type of printed matter, is different. For example, in a case of a photo album, high-quality printed matter is required, so a threshold value for strict inspection capable of detecting small black spots, scratches, blurs, and the like is easily set. However, in a case of a flyer, slight defects are tolerable in some cases, so that a threshold value for easy inspection is easily set. In this way, there is a correlation between the type of printed matter and the information related to a threshold value for inspection.

In addition, in general, the threshold value for inspection is set according to the information on an image to be printed using the print job. For example, in a print job with a large amount of solid black, a threshold value for easy inspection is likely to be set because print failures are less likely to occur compared to a print job with a small amount of solid black. In this way, there is a correlation between the information on an image to be printed using the print job and the information related to a threshold value for inspection.

In addition, there is a difference in quality requirements depending on an order. A threshold value for strict inspection is set for an order which requires high-quality printed matter. In this way, there is a correlation between the information on an order and the information related to a threshold value for inspection.

In a case where the occurrence of a print failure due to a mechanical cause in the printing apparatus 12 and the inspection apparatus 13 is known, the accuracy of the adjustment of the information related to a threshold value for inspection is improved. For example, in a case where a print failure occurs in a certain print job and the defect is due to a mechanical cause, the continuous occurrence of the same print failure is hardly considered thereafter in a case where the machine problem is resolved. That is, the noise generated in a case where a mechanical tuning is performed for the occurring print failure can be reduced. As described above, there is a correlation between the information on the printing apparatus 12 and the information on the inspection apparatus 13 and the information related to a threshold value for inspection.

The model storage unit 104 stores the trained neural network model.

The reception unit 105 receives input information related to a new print job to be estimated.

The input information includes the type of printed matter to be printed using the print job. For example, the type of printed matter “poster” acquired from the management apparatus 11 is received.

In addition, the input information may include information on an object or a color included in an image to be printed using the print job. For example, the ratio “30:70” between image information and text information of each page, the number of pages “5 pages” primarily composed of the image information, the number of pages “10 pages” primarily composed of the text information, the image density “30%”, and the primary color information “blue”, which are acquired from the management apparatus 11, are received.

In addition, the input information may include the information on an order of printed matter to be printed using the print job. For example, the information for identifying an order acquired from the management apparatus 11 is received.

The input information may also include the information on the printing apparatus 12 that processes the print job. Specifically, the information for identifying the printing apparatus 12 that processes the print job or the information for indicating a model, which is acquired from the management apparatus 11, is received.

In addition, the input information may include the information on the inspection apparatus 13 that performs inspection of the printed matter to be printed using the print job. Specifically, the information for identifying the inspection apparatus 13 or the information for indicating a model, which is acquired from the management apparatus 11, is received.

The estimation unit 106 estimates the information related to a threshold value for inspection corresponding to the received input information by using the trained neural network model stored in the model storage unit 104.

Specifically, various types of information included in the received input information are converted into a data structure (for example, a scalar value, a vector, and the like) that can be input to the trained neural network model to input to the trained neural network model, and the information related to a threshold value for inspection is estimated from the output of the trained model.

The output unit 107 sets the estimated information related to a threshold value for inspection with respect to the inspection apparatus 13. Specifically, the output unit 107 transmits the estimated information related to a threshold value for inspection to the inspection apparatus 13.

The inspection apparatus 13 performs inspection of the printed matter using the set information related to a threshold value for inspection. In this case, an operator visually inspects printed matter and, in a case where an inspection result obtained by the inspection apparatus 13 does not match an inspection result performed visually by the operator, the information related to a threshold value for inspection is adjusted by an operation of the operator. In this case, the collection unit 101 may acquire the information related to a threshold value for inspection after the adjustment as information related to a threshold value for correct answer inspection, and may collect a pair of input information related to the print job and the acquired information related to a threshold value for inspection as the training data.

Next, specific processing performed by each part of the information processing system 10 according to the present exemplary embodiment configured as described above will be described.

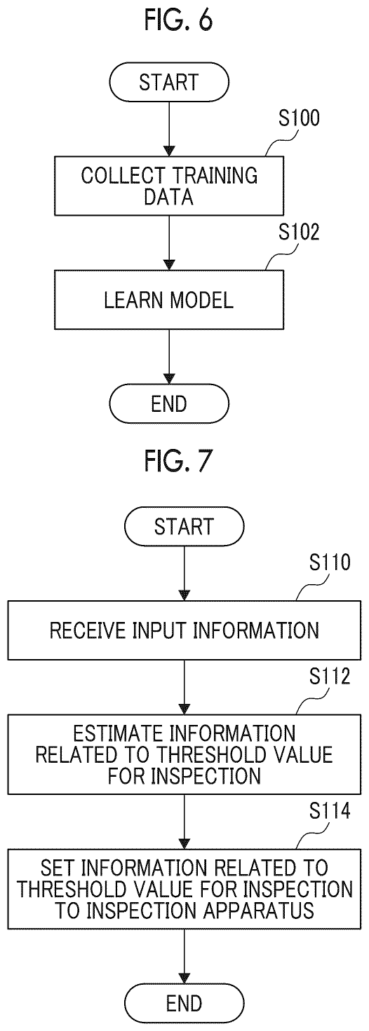

First, in the client computer 14, the CPU 14A reads out the training program from the ROM 14B or the storage 14D, and develops and executes the training program on the RAM 14C to perform a training process shown in FIG. 6.

In step S100, as the collection unit 101, the CPU 14A collects the training data that includes a pair of input information related to a past print job and information related to a threshold value for inspection corresponding to the input information, and stores the training data in the training data storage unit 102.

In step S102, as the training unit 103, the CPU 14A learns the neural network model to estimate the information related to a threshold value for inspection corresponding to the input information using the input information as input based on a plurality of training data, stores the trained neural network model in the model storage unit 104, and ends the training process.

Next, in the client computer 14, the CPU 14A reads an information processing program from the ROM 14B or the storage 14D and develops and executes the information processing program in the RAM 14C, so that an estimation process shown in FIG. 7 is performed. In this case, it is assumed that various types of information included in the input information related to a new print job to be estimated are input.

In step S110, as the reception unit 105, the CPU 14A receives the input information related to a new print job to be estimated, which is input by the user.

In step S112, as the estimation unit 106, the CPU 14A estimates the information related to a threshold value for inspection corresponding to the received input information by using the trained neural network model stored in the model storage unit 104.

In step S114, as the output unit 107, the CPU 14A sets the estimated information related to a threshold value for inspection with respect to the inspection apparatus 13 and ends the estimation process.

By performing the process in this way, a threshold value for inspection according to the print job may be output.

### Modification Example

The present invention is not limited to the above-described exemplary embodiment, and various modifications and applications are possible without departing from the gist of the present invention.

For example, a case has been described as an example in which the information related to a threshold value for inspection is estimated by receiving various types of information of the input information, but the information related to a threshold value for inspection may be estimated by receiving a part of the various types of information of the input information without receiving all the various types of information of the input information.

In addition, a case has been described as an example in which the client computer 14 trains a model and estimates the information related to a threshold value for inspection, but a configuration may be provided in which division is performed into a training apparatus that trains the model and an estimation apparatus that estimates the information related to a threshold value for inspection.

In addition, in the exemplary embodiment, a case is described as an example in which an inspection apparatus uses an inspection apparatus in a way that compares the scan image of the printed matter with the raster image of the printed matter, but an inspection apparatus in a way that compares one scan image of the printed matter with another scan image may also be used.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the “system” in the present exemplary embodiment is described as an example of a system configured to include a plurality of apparatus, but may be configured to include a single apparatus having functions of some parts of the plurality of apparatus.

The processes performed by the printing apparatus 12 according to the above exemplary embodiment may be processes performed by software, processes performed by hardware, or a combination of both. In addition, the processes performed by the printing apparatus 12 may be stored in a storage medium as a program and distributed.

In addition, the present disclosure is not limited to the above description, and various modifications other than the above description may be made without departing from the gist thereof.

Regarding the above exemplary embodiments, the following supplementary notes will be further disclosed.
(((1)))

An information processing system comprising:
a processor configured to:
in a case where input information including print job information is input, by inputting new input information including information related to a new print job to a trained model that has been trained in advance to output information related to a threshold value for inspection performed on printed matter to be printed using the print job, output information related to a threshold value for inspection corresponding to the new input information.
(((2)))

The information processing system according to (((1))),
wherein the information related to the new print job includes information related to a type of printed matter to be printed using the new print job or an image to be printed using the new print job.
(((3)))

The information processing system according to (((2))),
wherein the information related to the image to be printed using the new print job includes information on an object or information on a color, which are included in the image to be printed using the new print job.
(((4)))

The information processing system according to any one of (((1))) to (((3))),
wherein the new input information further includes information on an order of printed matter to be printed using the new print job.
(((5)))

The information processing system according to (((4))),
wherein the information on the order of printed matter to be printed using the new print job includes information for identifying the order of printed matter to be printed using the new print job.
(((6)))

The information processing system according to any one of (((1))) to (3))),
wherein the new input information further includes information on a printing apparatus that processes the new print job or information on an inspection apparatus that performs inspection of printed matter to be printed using the new print job.
(((7)))

The information processing system according to (((6))),
wherein the information on the printing apparatus includes information for identifying the printing apparatus, and the information on the inspection apparatus includes information for identifying the inspection apparatus.
(((8)))

An information processing program causing a computer to execute a process comprising:
outputting, in a case where input information including print job information is input, by inputting new input information including information related to a new print job to a trained model that has been trained in advance to output information related to a threshold value for inspection performed on printed matter to be printed using the print job, information related to a threshold value for inspection corresponding to the new input information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
in a case where input information including print job information is input, by inputting new input information including information related to a new print job to a trained model that has been trained in advance to output information related to a threshold value for inspection performed on printed matter to be printed using the print job, output information related to a threshold value for inspection corresponding to the new input information.

2. The information processing system according to claim 1,
wherein the information related to the new print job includes information related to a type of printed matter to be printed using the new print job or an image to be printed using the new print job.

3. The information processing system according to claim 2,
wherein the information related to the image to be printed using the new print job includes information on an object or information on a color, which are included in the image to be printed using the new print job.

4. The information processing system according to claim 1,
wherein the new input information further includes information on an order of printed matter to be printed using the new print job.

5. The information processing system according to claim 4,
wherein the information on the order of printed matter to be printed using the new print job includes information for identifying the order of printed matter to be printed using the new print job.

6. The information processing system according to claim 1,
wherein the new input information further includes information on a printing apparatus that processes the new print job or information on an inspection apparatus that performs inspection of printed matter to be printed using the new print job.

7. The information processing system according to claim 6,
wherein the information on the printing apparatus includes information for identifying the printing apparatus, and the information on the inspection apparatus includes information for identifying the inspection apparatus.

8. A non-transitory computer readable medium storing an information processing program causing a computer to execute a process comprising:
outputting, in a case where input information including print job information is input, by inputting new input information including information related to a new print job to a trained model that has been trained in advance to output information related to a threshold value for inspection performed on printed matter to be printed using the print job, information related to a threshold value for inspection corresponding to the new input information.

9. An information processing method comprising:
outputting, in a case where input information including print job information is input, by inputting new input information including information related to a new print job to a trained model that has been trained in advance to output information related to a threshold value for inspection performed on printed matter to be printed using the print job, information related to a threshold value for inspection corresponding to the new input information.
